(19) United States
(12) Patent Application Publication
(10) Pub. No.: US 2013/0129308 A1
(43) Pub. Date: May 23, 2013

(54) DISPLAY DEVICE WITH ADAPTIVE FAST NAVIGATION MODE

(71) Applicants: Keith Stoll Karn, Avon, NY (US); Noah Joseph Stupak, Rochester, NY (US); Michael J. Gerard, Webster, NY (US)

(72) Inventors: Keith Stoll Karn, Avon, NY (US); Noah Joseph Stupak, Rochester, NY (US); Michael J. Gerard, Webster, NY (US)

(21) Appl. No.: 13/299,383

(22) Filed: Nov. 18, 2011

(51) Int. Cl. H04N 5/775

(52) U.S. Cl. 386/230; 386/E05.07

(57) ABSTRACT

A digital video display device having an adaptive fast navigation mode for navigating through a digital video sequence having a time sequence of video frames, comprising a display, a user interface including user controls and a data processing system. A program memory stores instructions configured to perform the steps of: selecting a digital video sequence; determining a time duration associated with the selected digital video sequence, initiating a fast navigation operation in response to user activation of an appropriate user control, determining a fast navigation speed responsive to the time duration of the selected digital video sequence, designating a particular video frame in the selected digital video sequence to be a current video frame; and periodically updating the designation of the current video frame in accordance with the determined fast navigation speed.

### CROSS-REFERENCE TO RELATED APPLICATIONS

Reference is made to commonly-assigned, co-pending U.S. patent application Ser. No. 13/100,461 (Docket 96800), entitled “Digital camera user interface for video trimming”, by Boncha et al., which is incorporated herein by reference.

### FIELD OF THE INVENTION

This invention pertains to the field of digital video display devices, and more particularly to a digital camera having a user interface which provides fast navigation modes.

### BACKGROUND OF THE INVENTION

Digital capture devices, such as digital cameras and camera phones typically capture and store both still digital images and video clips. The video clips can be of very different lengths, ranging from a few seconds in duration to many minutes or tens of minutes in duration.

Digital capture devices typically include a color display which is used to display captured still digital images and video clips. Other types of display devices, such as portable DVD players and tablet computers, can also be used to display video clips.

These digital image display devices typically include a graphic user interface (GUI) which enables video clips to be selected and viewed. It is common to include user interface features such as “fast forward” and “fast reverse” as part of the GUI, in order to enable users to quickly locate a portion of video clip which they would like to view. Some digital image display devices permit a user to edit video clips, for example by “trimming” away an uninteresting portion of the video clip in order to make the clip more exciting. Editing functions often include a “fast forward” and “fast reverse” mode, in order to quickly review the video clip and find the “in point” and “out point” where the trimmed video will begin and end.

It is known to provide a user-programmable fast forward or fast reverse feature, as described in U.S. Patent Application Publication 2006/0078297 to Nishikawa et al., entitled “Method and apparatus for customizing content navigation.” This patent application describes a digital video recorder (DVR) which enables a user to navigate through pre-recorded content in accordance with user preferences. The user preferences include fast-forward (FF) and fast reverse (RR) speeds. However, the same user-selected fast forward and fast reverse speeds are used for all content, whether the content is a very short program or a very long program.

It is also known to provide accurate fast forward rates when performing “trick play” video playback, as described in U.S. Patent Application Publication 2008/0166100 to Ross, entitled “Accurate fast forward rate when performing trick play with variable distance between frames.” This patent application describes a time reference clock which is incremented at a predetermined fast-forward rate, and compared with timing information associated with pictures, so that the “fast forward” speed does not vary even if, for example, the frequency of intraframe coded frame (e.g. “I frames”) varies. However, the same playback speeds are used independent of whether the content is a very short program or a very long program.

It is also known to provide pre-produced alternative content for use during “trick play” video playback, as described in U.S. Patent Application Publication 2010/0290761 to Drake et al., entitled “System and method for providing time-adapted video content.” This patent describes a method for selecting one of a plurality of pre-produced alternative contents based on the current playback speed, in order to make the video contents more intelligible during trick mode playback. However, the same playback speeds are used independent of whether the content is a very short program or a very long program.

It is also known to provide pointers to units of information which encode video programs on DVD discs, as described in U.S. Pat. No. 7,283,723 to Wilson et al., entitled “Method and device for recording real-time information.” This patent describes a method for determining pointers to units of information in a far forward direction, which have not yet been recorded. Standard playback devices play the recorded material in trick play modes with only minor deviations in the fast forward speed.

It is also known to use the time duration of a video program on a DVD disc to determine the average playback time for each VOBU (Video Object Unit) used to encode the program, as described in U.S. Patent Application Publication 2007/0286570 to Nagata et al., entitled “Playback apparatus and playback method.” This patent uses the playback time and the number of VOBU to determine an average playback time for one VOBU, during high-speed playback and time search. However, the same playback speeds are used, independent of whether the content is a very short program or a very long program.

There remains a need to provide a user interface using a limited number of user controls, which can nevertheless enable a user to quickly and easily navigate through video clips of various time durations.

### SUMMARY OF THE INVENTION

The present invention represents a digital video display device having an adaptive fast navigation mode for navigating through a digital video sequence having a time sequence of video frames, comprising:

a display;

a user interface including one or more user controls;

a data processing system;

a program memory communicatively connected to the data processing system and storing instructions configured to cause the data processing system to implement a method for providing the adaptive fast navigation mode, wherein the method includes:
selecting a digital video sequence stored in a processor-accessible memory;
determining a time duration associated with the selected digital video sequence;
initiating a fast navigation operation in response to user activation of an appropriate user control;
determining a fast navigation speed responsive to the time duration of the selected digital video sequence;
designating a particular video frame in the selected digital video sequence to be a current video frame; and
periodically updating the designation of the current video frame in accordance with the determined fast navigation speed.

The present invention has the advantage that the speed of the fast navigation process adapts to the time duration of the digital video sequence. This enables navigation through long digital video sequences without requiring an excessive time period, while still enabling navigation through short digital video sequences at a reasonable navigation speed.

It has the additional advantage that the fast navigation process can be used to provide fast forward or fast reverse features in a video playback application. It can also be used in applications such as video trimming where it is necessary to navigate to a desired frame in a digital video sequence.

### BRIEF DESCRIPTION OF THE DRAWINGS

FIG. 1 is a high-level diagram showing the components of a digital camera system;

FIG. 2 is a flow diagram depicting typical image processing operations used to process digital images in a digital camera;

FIG. 3A is a diagram illustrating one embodiment of a back of a digital camera according to the present invention;

FIGS. 3B-3D are diagrams illustrating alternate embodiments of user controls;

FIG. 4 is a flowchart showing steps for providing an adaptive fast navigation mode for a digital video display device;

FIGS. 5A-5F are diagrams illustrating exemplary user interface screens for one exemplary embodiment of an adaptive fast navigation mode;

FIGS. 6A-6D are diagrams illustrating exemplary user interface screens for another exemplary embodiment of an adaptive fast navigation mode;

FIG. 7 is a diagram illustrating the designation of frames to be displayed for video clips having different durations;

FIG. 8 is a state diagram illustrating the operation of various user controls in accordance with an exemplary embodiment the present invention;

FIG. 9 is a state diagram illustrating the operation of various user controls in accordance with another exemplary embodiment the present invention.

It is to be understood that the attached drawings are for purposes of illustrating the concepts of the invention and may not be to scale.

### DETAILED DESCRIPTION OF THE INVENTION

In the following description, a preferred embodiment of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, a computer program for performing the method of the present invention can be stored in a non-transitory, tangible computer readable storage medium, which can include, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program having instructions for controlling one or more computers to practice the method according to the present invention.

Because digital cameras employing imaging devices and related circuitry for signal capture and processing, and display are well known, the present description will be directed in particular to elements forming part of, or cooperating more directly with, the method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

The following description of a digital camera will be familiar to one skilled in the art. It will be obvious that there are many variations of this embodiment that are possible and are selected to reduce the cost, add features or improve the performance of the camera.

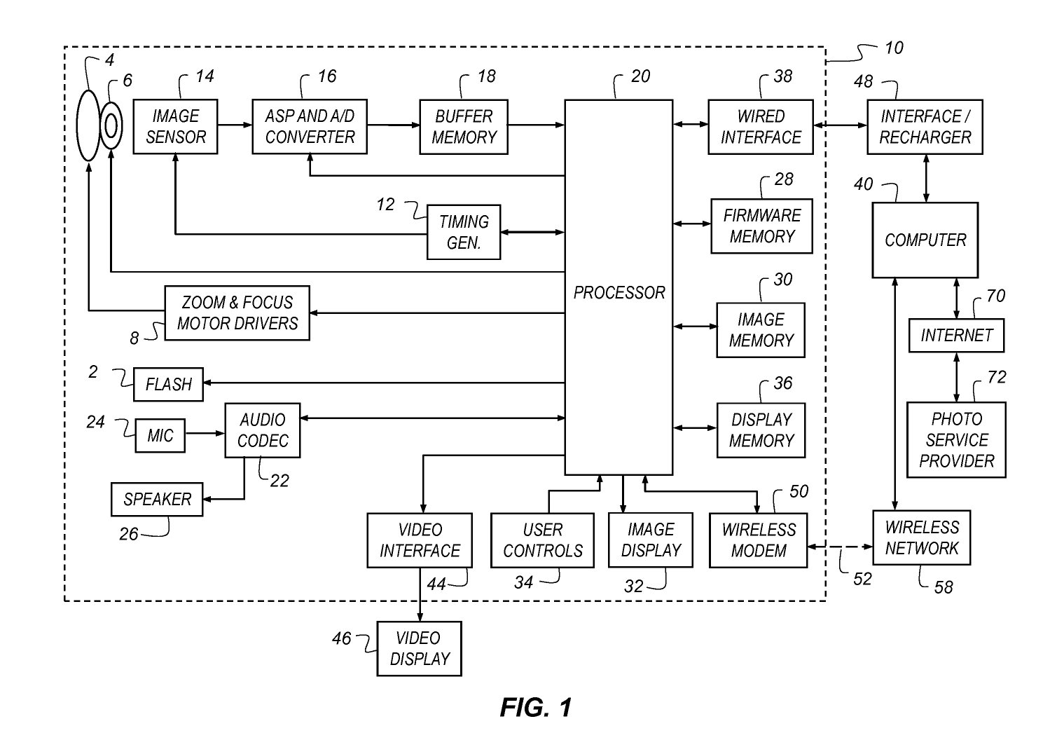

FIG. 1 depicts a block diagram of a digital photography system, including a digital camera 10. Preferably, the digital camera 10 is a portable battery operated device, small enough to be easily handheld by a user when capturing and reviewing images. The digital camera 10 produces digital images that are stored as digital image files using image memory 30. The phrase “digital image” or “digital image file,” as used herein, refers to any digital image file, such as a digital still image or a digital video file.

In some embodiments, the digital camera 10 captures both motion video images and still images. The digital camera 10 can also include other functions, including, but not limited to, the functions of a digital music player (e.g. an MP3 player), a mobile telephone, a GPS receiver, or a programmable digital assistant (PDA).

The digital camera 10 includes a lens 4 having an adjustable aperture and adjustable shutter 6. In a preferred embodiment, the lens 4 is a zoom lens and is controlled by zoom and focus motor drivers 8. The lens 4 focuses light from a scene (not shown) onto an image sensor 14, for example, a single-chip color CCD or CMOS image sensor. The lens 4 is one type optical system for forming an image of the scene on the image sensor 14. In other embodiments, the optical system may use a fixed focal length lens with either variable or fixed focus.

The output of the image sensor 14 is converted to digital form by Analog Signal Processor (ASP) and Analog-to-Digital (A/D) converter 16, and temporarily stored in buffer memory 18. The image data stored in buffer memory 18 is subsequently manipulated by a processor 20, using embedded software programs (e.g. firmware) stored in firmware memory 28. In some embodiments, the software program is permanently stored in firmware memory 28 using a read only memory (ROM). In other embodiments, the firmware memory 28 can be modified by using, for example, Flash EPROM memory. In such embodiments, an external device can update the software programs stored in firmware memory 28 using the wired interface 38 or the wireless modem 50. In such embodiments, the firmware memory 28 can also be used to store image sensor calibration data, user setting selections and other data which must be preserved when the camera is turned off. In some embodiments, the processor 20 includes a program memory (not shown), and the software programs stored in the firmware memory 28 are copied into the program memory before being executed by the processor 20.

It will be understood that the functions of processor 20 can be provided using a single programmable processor or by using multiple programmable processors, including one or more digital signal processor (DSP) devices. Alternatively, the processor 20 can be provided by custom circuitry (e.g., by one or more custom integrated circuits (ICs) designed specifically for use in digital cameras), or by a combination of programmable processor(s) and custom circuits. It will be understood that connectors between the processor 20 from some or all of the various components shown in FIG. 1 can be made using a common data bus. For example, in some embodiments the connection between the processor 20, the buffer memory 18, the image memory 30, and the firmware memory 28 can be made using a common data bus.

The processed images are then stored using the image memory 30. It is understood that the image memory 30 can be any form of memory known to those skilled in the art including, but not limited to, a removable Flash memory card, internal Flash memory chips, magnetic memory, or optical memory. In some embodiments, the image memory 30 can include both internal Flash memory chips and a standard interface to a removable Flash memory card, such as a Secure Digital (SD) card. Alternatively, a different memory card format can be used, such as a micro SD card, Compact Flash (CF) card, MultiMedia Card (MMC), xD card or Memory Stick.

The image sensor 14 is controlled by a timing generator 12, which produces various clocking signals to select rows and pixels and synchronizes the operation of the ASP and A/D converter 16. The image sensor 14 can have, for example, 12.4 megapixels (4088×3040 pixels) in order to provide a still image file of approximately 4000×3000 pixels. To provide a color image, the image sensor is generally overlaid with a color filter array, which provides an image sensor having an array of pixels that include different colored pixels. The different color pixels can be arranged in many different patterns. As one example, the different color pixels can be arranged using the well-known Bayer color filter array, as described in commonly assigned U.S. Pat. No. 3,971,065, “Color imaging array” to Bayer, the disclosure of which is incorporated herein by reference. As a second example, the different color pixels can be arranged as described in commonly assigned U.S. Patent Application Publication 2007/0024931 to Compton and Hamilton, entitled “Image sensor with improved light sensitivity,” the disclosure of which is incorporated herein by reference. These examples are not limiting, and many other color patterns may be used.

It will be understood that the image sensor 14, timing generator 12, and ASP and A/D converter 16 can be separately fabricated integrated circuits, or they can be fabricated as a single integrated circuit as is commonly done with CMOS image sensors. In some embodiments, this single integrated circuit can perform some of the other functions shown in FIG. 1, including some of the functions provided by processor 20.

The image sensor 14 is effective when actuated in a first mode by timing generator 12 for providing a motion sequence of lower resolution sensor image data, which is used when capturing video images and also when previewing a still image to be captured, in order to compose the image. This preview mode sensor image data can be provided as HD resolution image data, for example, with 1280×720 pixels, or as VGA resolution image data, for example, with 640×480 pixels, or using other resolutions which have significantly columns and rows of data, compared to the resolution of the image sensor.

The preview mode sensor image data can be provided by combining values of adjacent pixels having the same color, or by eliminating some of the pixels values, or by combining some color pixels values while eliminating other color pixel values. The preview mode image data can be processed as described in commonly assigned U.S. Pat. No. 6,292,218 to Parulski, et al., entitled “Electronic camera for initiating capture of still images while previewing motion images,” which is incorporated herein by reference.

The image sensor 14 is also effective when actuated in a second mode by timing generator 12 for providing high resolution still image data. This final mode sensor image data is provided as high resolution output image data, which for scenes having a high illumination level includes all of the pixels of the image sensor, and can be, for example, a 12 megapixel final image data having 4000×3000 pixels. At lower illumination levels, the final sensor image data can be provided by “binning” some number of like-colored pixels on the image sensor, in order to increase the signal level and thus the “ISO speed” of the sensor.

The zoom and focus motor drivers 8 are controlled by control signals supplied by the processor 20, to provide the appropriate focal length setting and to focus the scene onto the image sensor 14. The exposure level of the image sensor 14 is controlled by controlling the f/number and exposure time of the adjustable aperture and adjustable shutter 6, the exposure period of the image sensor 14 via the timing generator 12, and the gain (i.e., ISO speed) setting of the ASP and A/D converter 16. The processor 20 also controls a flash 2 which can illuminate the scene. In some embodiments of the present invention, the flash 2 has an adjustable correlated color temperature. For example, the flash disclosed in U.S. Patent Application Publication 2008/0297027 to Miller et al., entitled “Lamp with adjustable color,” can be used to produce illumination having different color balances for different environmental conditions, such as having a higher proportion of red light when the digital camera 10 is operated underwater.

The lens 4 of the digital camera 10 can be focused in the first mode by using “through-the-lens” autofocus, as described in commonly-assigned U.S. Pat. No. 5,668,597, entitled “Electronic Camera with Rapid Automatic Focus of an Image upon a Progressive Scan Image Sensor” to Parulski et al., which is incorporated herein by reference. This is accomplished by using the zoom and focus motor drivers 8 to adjust the focus position of the lens 4 to a number of positions ranging between a near focus position to an infinity focus position, while the processor 20 determines the closest focus position which provides a peak sharpness value for a central portion of the image captured by the image sensor 14. The focus distance can be stored as metadata in the image file, along with other lens and camera settings.

The processor 20 produces menus and low resolution color images that are temporarily stored in display memory 36 and are displayed on the image display 32. The image display 32 is typically an active matrix color liquid crystal display (LCD), although other types of displays, such as organic light emitting diode (OLED) displays, can be used. A video interface 44 provides a video output signal from the digital camera 10 to a video display 46, such as a flat panel HDTV display. In preview mode, or video mode, the digital image data from buffer memory 18 is manipulated by processor 20 to form a series of motion preview images that are displayed, typically as color images, on the image display 32. In review mode, the images displayed on the image display 32 are produced using the image data from the digital image files stored in image memory 30.

The graphical user interface displayed on the image display 32 includes various user control elements which can be selected by user controls 34. The user controls 34 are used to select various camera modes, such as video capture mode, still capture mode, and review mode, and to initiate capture of still images and recording of motion images. In some embodiments, the first mode described above (i.e. still preview mode) is initiated when the user partially depresses an image capture button, which is one of the user controls 34, and the second mode (i.e., still image capture mode) is initiated when the user fully depresses the image capture button. The user controls 34 are also used to turn on the camera, control the lens 4, and initiate the picture taking process. User controls 34 typically include some combination of buttons, rocker switches, joysticks, or rotary dials. In some embodiments, some of the user controls 34 are provided by using a touch screen overlay on the image display 32 having one or more touch-sensitive user control elements.

An audio codec 22 connected to the processor 20 receives an audio signal from a microphone 24 and provides an audio signal to a speaker 26. These components can be to record and playback an audio track, along with a video sequence or still image. If the digital camera 10 is a multi-function device such as a combination camera and mobile phone, the microphone 24 and the speaker 26 can be used for telephone conversation. In some embodiments, microphone 24 is capable of recording sounds in air and also in an underwater environment when the digital camera 10 is used to record underwater images. In other embodiments, the digital camera 10 includes both a conventional air microphone as well as an underwater microphone (hydrophone) capable of recording underwater sounds.

In some embodiments, the speaker 26 can be used as part of the user interface, for example to provide various audible signals which indicate that a user control has been depressed, or that a particular mode has been selected. In some embodiments, the microphone 24, the audio codec 22, and the processor 20 can be used to provide voice recognition, so that the user can provide a user input to the processor 20 by using voice commands, rather than user controls 34. The speaker 26 can also be used to inform the user of an incoming phone call. This can be done using a standard ring tone stored in firmware memory 28, or by using a custom ring-tone downloaded from a wireless network 58 and stored in the image memory 30. In addition, a vibration device (not shown) can be used to provide a silent (e.g., non audible) notification of an incoming phone call.

The processor 20 also provides additional processing of the image data from the image sensor 14, in order to produce rendered sRGB image data which is compressed and stored within a “finished” image file, such as a well-known Exif-JPEG image file, in the image memory 30.

The digital camera 10 can be connected via the wired interface 38 to an interface/recharger 48, which is connected to a computer 40, which can be a desktop computer or portable computer located in a home or office. The wired interface 38 can conform to, for example, the well-known USB 2.0 interface specification. The interface/recharger 48 can provide power via the wired interface 38 to a set of rechargeable batteries (not shown) in the digital camera 10.

The digital camera 10 can include a wireless modem 50, which interfaces over a radio frequency band 52 with the wireless network 58. The wireless modem 50 can use various wireless interface protocols, such as the well-known Bluetooth wireless interface or the well-known 802.11 wireless interface. The computer 40 can upload images via the Internet 70 to a photo service provider 72, such as the Kodak EasyShare Gallery. Other devices (not shown) can access the images stored by the photo service provider 72.

In alternative embodiments, the wireless modem 50 communicates over a radio frequency (e.g. wireless) link with a mobile phone network (not shown), such as a 3 GSM network, which connects with the Internet 70 in order to upload digital image files from the digital camera 10. These digital image files can be provided to the computer 40 or the photo service provider 72.

In some embodiments, the digital camera 10 is a water proof digital camera capable of being used to capture digital images underwater and under other challenging environmental conditions, such as in rain or snow conditions. For example, the digital camera 10 can be used by scuba divers exploring a coral reef or by children playing at a beach. To prevent damage to the various camera components, in these embodiments the digital camera 10 includes a watertight housing (not shown).

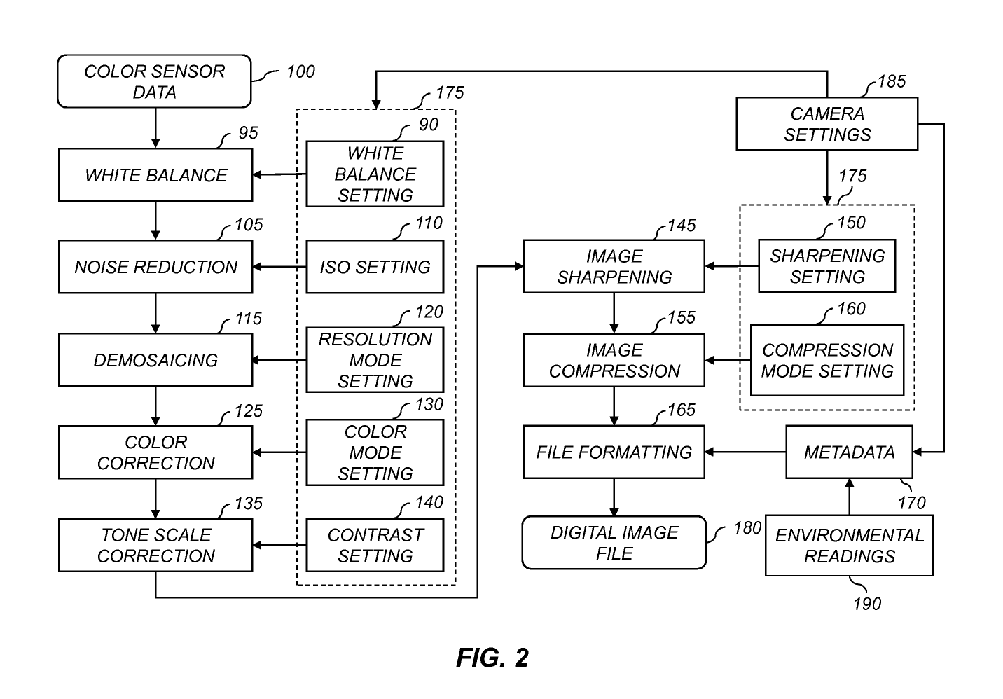

FIG. 2 is a flow diagram depicting image processing operations that can be performed by the processor 20 in the digital camera 10 (FIG. 1) in order to process color sensor data 100 from the image sensor 14 output by the ASP and A/D converter 16. In some embodiments, the processing parameters used by the processor 20 to manipulate the color sensor data 100 for a particular digital image are determined by various user settings 175, which are typically associated with photography modes that can be selected via the user controls 34, which enable the user to adjust various camera settings 185 in response to menus displayed on the image display 32. In a preferred embodiment, the user control elements available in the menus are adjusted responsive to sensed environmental conditions.

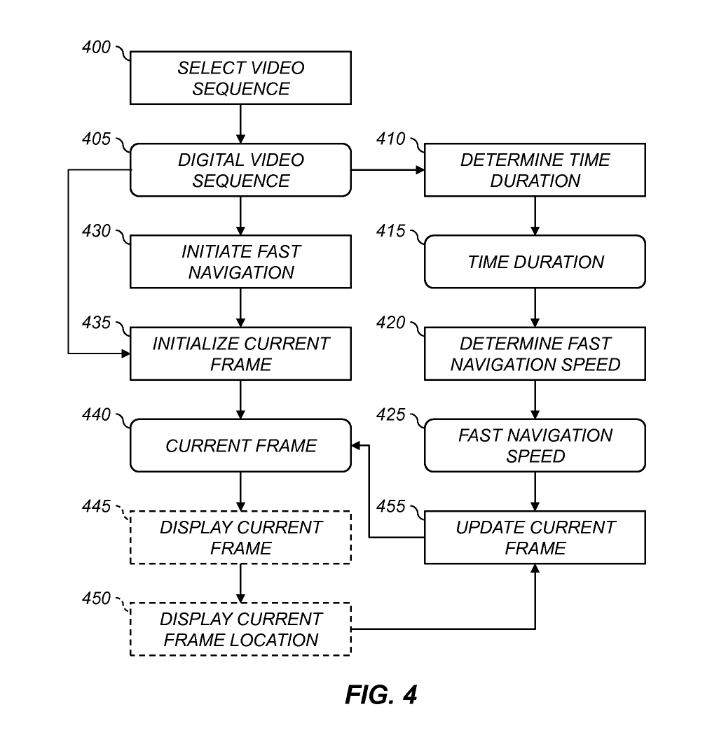

The color sensor data 100 which has been digitally converted by the ASP and A/D converter 16 is manipulated by a white balance step 95. In some embodiments, this processing can be performed using the methods described in commonly-assigned U.S. Pat. No. 7,542,077 to Miki, entitled “White balance adjustment device and color identification device,” the disclosure of which is herein incorporated by reference. The white balance can be adjusted in response to a white balance setting 90, which can be manually set by a user, or can be automatically set to different values when the camera is used in different environmental conditions, as will be described later in reference to FIG. 4.

The color image data is then manipulated by a noise reduction step 105 in order to reduce noise from the image sensor 14. In some embodiments, this processing can be performed using the methods described in commonly-assigned U.S. Pat. No. 6,934,056 to Gindele et al., entitled “Noise cleaning and interpolating sparsely populated color digital image using a variable noise cleaning kernel,” the disclosure of which is herein incorporated by reference. The level of noise reduction can be adjusted in response to an ISO setting 110, so that more filtering is performed at higher ISO exposure index setting.

The color image data is then manipulated by a demosaicing step 115, in order to provide red, green and blue (RGB) image data values at each pixel location. Algorithms for performing the demosaicing step 115 are commonly known as color filter array (CFA) interpolation algorithms or “deBayering” algorithms. In one embodiment of the present invention, the demosaicing step 115 can use the luminance CFA interpolation method described in commonly-assigned U.S. Pat. No. 5,652,621, entitled “Adaptive color plane interpolation in single sensor color electronic camera,” to Adams et al., the disclosure of which is incorporated herein by reference. The demosaicing step 115 can also use the chrominance CFA interpolation method described in commonly-assigned U.S. Pat. No. 4,642,678, entitled “Signal processing method and apparatus for producing interpolated chrominance values in a sampled color image signal,” to Cok, the disclosure of which is herein incorporated by reference.

In some embodiments, the user can select between different pixel resolution modes, so that the digital camera can produce a smaller size image file. Multiple pixel resolutions can be provided as described in commonly-assigned U.S. Pat. No. 5,493,335, entitled “Single sensor color camera with user selectable image record size,” to Parulski et al., the disclosure of which is herein incorporated by reference. In some embodiments, a resolution mode setting 120 can be selected by the user to be full size (e.g. 3,000×2,000 pixels), medium size (e.g. 1,500×1000 pixels) or small size (750×500 pixels).

The color image data is color corrected in color correction step 125. In some embodiments, the color correction is provided using a 3×3 linear space color correction matrix, as described in commonly-assigned U.S. Pat. No. 5,189,511, entitled “Method and apparatus for improving the color rendition of hardcopy images from electronic cameras” to Parulski, et al., the disclosure of which is incorporated herein by reference. In some embodiments, different user-selectable color modes can be provided by storing different color matrix coefficients in firmware memory 28 of the digital camera 10. For example, four different color modes can be provided, so that the color mode setting 130 is used to select one of the following color correction matrices:

Setting 1 (normal color reproduction)

$$[ \begin{matrix}{R}_{out} \\ {G}_{out} \\ {B}_{out}\end{matrix} ] = [ \begin{matrix}1.50 & - 0.30 & - 0.20 \\ - 0.40 & 1.80 & - 0.40 \\ - 0.20 & - 0.20 & 1.40\end{matrix} ] [ \begin{matrix}{R}_{in} \\ {G}_{in} \\ {B}_{in}\end{matrix} ] \qquad ( 1 )$$

Setting 2 (saturated color reproduction)

$$[ \begin{matrix}{R}_{out} \\ {G}_{out} \\ {B}_{out}\end{matrix} ] = [ \begin{matrix}2.00 & - 0.60 & - 0.40 \\ - 0.80 & 2.60 & - 0.80 \\ - 0.40 & - 0.40 & 1.80\end{matrix} ] [ \begin{matrix}{R}_{in} \\ {G}_{in} \\ {B}_{in}\end{matrix} ] \qquad ( 2 )$$

Setting 3 (de-saturated color reproduction)

$$[ \begin{matrix}{R}_{out} \\ {G}_{out} \\ {B}_{out}\end{matrix} ] = [ \begin{matrix}1.25 & - 0.15 & - 0.10 \\ - 0.20 & 1.40 & - 0.20 \\ - 0.10 & - 0.10 & 1.20\end{matrix} ] [ \begin{matrix}{R}_{in} \\ {G}_{in} \\ {B}_{in}\end{matrix} ] \qquad ( 3 )$$

Setting 4 (monochrome)

$$[ \begin{matrix}{R}_{out} \\ {G}_{out} \\ {B}_{out}\end{matrix} ] = [ \begin{matrix}0.30 & 0.60 & 0.10 \\ 0.30 & 0.60 & 0.10 \\ 0.30 & 0.60 & 0.10\end{matrix} ] [ \begin{matrix}{R}_{in} \\ {G}_{in} \\ {B}_{in}\end{matrix} ] \qquad ( 4 )$$

Setting 5 (nominal underwater color reproduction)

$$[ \begin{matrix}{R}_{out} \\ {G}_{out} \\ {B}_{out}\end{matrix} ] = [ \begin{matrix}3.00 & - 0.30 & - 0.20 \\ - 0.80 & 1.80 & - 0.40 \\ - 0.40 & - 0.20 & 1.40\end{matrix} ] [ \begin{matrix}{R}_{in} \\ {G}_{in} \\ {B}_{in}\end{matrix} ] \qquad ( 5 )$$

The color image data is also manipulated by a tone scale correction step 135. In some embodiments, the tone scale correction step 135 can be performed using a one-dimensional look-up table as described in U.S. Pat. No. 5,189,511, cited earlier. In some embodiments, a plurality of tone scale correction look-up tables is stored in the firmware memory 28 in the digital camera 10. These can include look-up tables which provide a “normal” tone scale correction curve, a “high contrast” tone scale correction curve, and a “low contrast” tone scale correction curve. A user selected contrast setting 140 is used by the processor 20 to determine which of the tone scale correction look-up tables to use when performing the tone scale correction step 135.

The color image data is also manipulated by an image sharpening step 145. In some embodiments, this can be provided using the methods described in commonly-assigned U.S. Pat. No. 6,192,162 entitled “Edge enhancing colored digital images” to Hamilton, et al., the disclosure of which is incorporated herein by reference. In some embodiments, the user can select between various sharpening settings, including a “normal sharpness” setting, a “high sharpness” setting, and a “low sharpness” setting. In this example, the processor 20 uses one of three different edge boost multiplier values, for example 2.0 for “high sharpness,” 1.0 for “normal sharpness,” and 0.5 for “low sharpness” levels, responsive to a sharpening setting 150 selected by the user of the digital camera 10. In some embodiments, different image sharpening algorithms can be manually or automatically selected, depending on the environmental condition.

The color image data is also manipulated by an image compression step 155. In some embodiments, the image compression step 155 can be provided using the methods described in commonly-assigned U.S. Pat. No. 4,774,574, entitled “Adaptive block transform image coding method and apparatus” to Daly et al., the disclosure of which is incorporated herein by reference. In some embodiments, the user can select between various compression settings. This can be implemented by storing a plurality of quantization tables, for example, three different tables, in the firmware memory 28 of the digital camera 10. These tables provide different quality levels and average file sizes for the compressed digital image file 180 to be stored in the image memory 30 of the digital camera 10. A user selected compression mode setting 160 is used by the processor 20 to select the particular quantization table to be used for the image compression step 155 for a particular image.

The compressed color image data is stored in a digital image file 180 using a file formatting step 165. The image file can include various metadata 170. Metadata 170 is any type of information that relates to the digital image, such as the model of the camera that captured the image, the size of the image, the date and time the image was captured, and various camera settings, such as the lens focal length, the exposure time and F/# of the lens, and whether or not the camera flash fired. In some embodiments, the metadata 170 can also include one or more environmental readings 190 provided by appropriate environmental sensors associated with the digital camera 10. For example, an underwater sensor (not shown) can be used to provide an environmental reading indicating whether the digital camera 10 is being operated underwater. Similarly, a Global Positioning System (GPS) sensor (not shown) can be used to provide an environmental reading indicating a geographical location, or an inertial motion sensor such as a gyroscope or an accelerometer can be used to provide an environmental reading indicating a camera motion or orientation. In a preferred embodiment, all of this metadata 170 is stored using standardized tags within the well-known Exif-JPEG still image file format.

In accordance with the present invention, there are provided methods to perform a number of user interface tasks on a device having a small image display 32 using a minimal set of user controls. While there have been many different user interfaces for digital cameras and other portable electronic devices that have been disclosed in the prior art, they are typically designed to work with devices that have large image displays 32 and a large number of different buttons or touch activated controls. However, such components add significant cost to the device. Therefore, to produce low-cost devices, there is a desire to minimize the size of the display and the number of user controls. However, this has presented significant challenges relative to designing user interfaces that allow users to perform some common tasks in an intuitive and efficient fashion. The present invention is directed to solutions to this problem for several important tasks. Specifically, user interface methods are described for performing fast forward and fast reverse operations. These operations are useful for navigating through a captured video during a video reviewing process or a video editing process. These methods are particularly well-suited for image displays 32 that are not touch-sensitive and have a diagonal dimension of less than 2 inches, although they can also be employed for touch sensitive displays and larger displays.

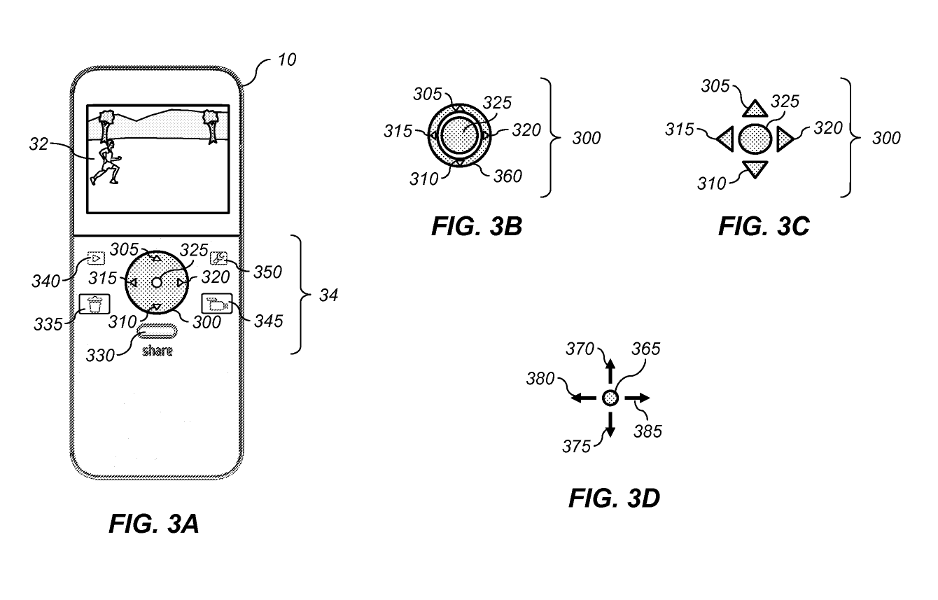

FIG. 3A is a diagram showing a rear view of the digital camera 10 according to one exemplary embodiment. The digital camera includes an image display 32, as well as various user controls 34. According to a preferred embodiment, the user controls 34 include a set of five inputs: an up input, a down input, a left input, a right input, and a confirmation input. In the exemplary embodiment of FIG. 3A, these controls are provided by a five-way controller 300. The five-way controller 300 includes five buttons: an up input button 305, a down input button 310, a left input button 315, a right input button 320, and a confirmation input button 325. The digital camera 10 can also include any other user controls that are known in the art. In the embodiment of FIG. 3A, the user controls 34 also include a share button 330, a delete button 335, a review button 340, capture mode button 345, and a tools button 350.

In the embodiment of FIG. 3A the five-way controller 300 is a solid circular disk, wherein each of the buttons are activated by pressing on an appropriate location on the circular disk. In other embodiments, the five-way controller 300 can include a controller ring 360 surrounding a separate confirmation input button 325 as is illustrated in FIG. 3B. In this configuration, the controller ring 360 provides the up input button 305, the down input button 310, the left input button 315 and the right input button 320, which are activated by pressing on the corresponding side of the controller ring 360.

In other embodiments, the five inputs (i.e., the up input, the down input, the left input, the right input, and the confirmation input) can be provided by other types of user controls 34 that are well-known in the art. For example, FIG. 3C shows a configuration where the five inputs are provided by five individual buttons (i.e., up input button 305, down input button 310, left input button 315, right input button 320, and confirmation input button 325). Similarly, FIG. 3D shows another configuration where the five inputs are provided by a joy stick 365. The joy stick 365 can be pushed in an up direction 370 to provide the up input, in a down direction 375 to provide the down input, in a left direction 380 to provide the left input, and in a right direction 385 to provide the right input. The confirmation input can be provided by pressing on the end of the joy stick 365, or alternately by a separate confirmation input button (not shown).

A method for providing a digital display device having an adaptive fast navigation mode will now be described with reference to FIG. 4. This method will be described in the context of the digital camera 10 of FIG. 1, which includes video image capture capabilities and which has been used to capture one or more digital video sequences. However, it will be obvious to one skilled in the art that it is also applicable to a wide variety of different portable electronic display devices such as cell-phones and digital media players. The method is well-suited to use with devices having a relatively small size and a limited set of user controls The method is particularly suitable for use with digital cameras 10 having a small size and a limited set of user controls.

A select video sequence step 400 is used to select a previously captured digital video sequence 405 which is stored in a processor-accessible memory, such as image memory 30, which is accessible to processor 20. The select video sequence step 400 can be performed using any convenient user controls known in the art. In some embodiments, the user can perform this step by entering a review mode using the review button 340 (FIG. 3A). The user can then use the user controls 34 to select a particular digital video sequence. For example, the left input button 315 and the right input button 320 can be used to sequence through the previously captured digital still images and digital video sequences that are stored in the image memory 30 (FIG. 1). When the desired digital video sequence has been located, the confirmation input button 325 can be used to select it.

Once a particular digital video sequence 405 has been selected, the user can perform various actions. For example, the selected digital video sequence 405 can be played, or it can be edited. One type of video editing operation that can be performed in accordance with the present invention is a video trimming operation, in which the user can trim one or both ends of the selected digital video sequence 405 to provide a shorter trimmed digital video sequence containing only a portion of the selected digital video sequence. For example, the user may desire to trim the selected digital video sequence to include only the most interesting portion. The video trimming operation involves selecting a start frame and an end frame, designating the portion of the selected digital video sequence to be included in the trimmed digital video sequence.

An initiate fast navigation step 430 is used to initiate a fast navigation operation. Fast navigation operations are useful for many video playback and editing processes. For example, during playback of the digital video sequence 405 the user may desire to move quickly through the video frames to find the portion of the digital video sequence 405 that they would like to play. Similarly, during a video trimming operation, the user may desire to move quickly through the video frames to locate the start frame or the end frame to be used in the trimmed digital video sequence.

A determine time duration step 410 is used to determine a time duration 415 for the digital video sequence 405. The time duration 415 provides an indication of the length of the digital video sequence 405. In some embodiments, the time duration 415 is the total time duration for the selected digital video sequence 405. In other embodiments, the time duration 415 is the time interval between a current frame 440 and the last frame in the digital video sequence 405 if the fast navigation operation is a fast forward navigation operation, and the time duration 415 is the time duration between the current frame 440 and the first frame in the digital video sequence 405 if the fast navigation operation is a fast reverse navigation operation.

The time duration 415 can be represented in any useful form. For example, in some embodiments the time duration 415 can be a time interval in time units (e.g., seconds). In other embodiments, the time duration 415 can be a frame count for the digital video sequence 405, which will be proportional to the time interval.

A determine fast navigation speed step 420 is used to determine a fast navigation speed 425 responsive to the time duration 415. In a preferred embodiment, a higher fast navigation speed 425 will be determined for longer time durations 415, and a lower fast navigation speed 425 will be determined for shorter time durations 415.

In some embodiments, the fast navigation speed 425 can be determined from the time duration 415 using a mathematical formula. In other embodiments, the fast navigation speed 425 can be determined using some other mechanism. For example, a set of predefined set of fast navigations speeds can be defined, each associated with a corresponding predefined range of time durations.

In this case, the fast navigation speed 425 can be determined by identifying the predefined range of time durations that includes the time duration 415 of the selected digital video sequence 405. In some embodiments, the predefined set of fast navigation speeds and ranges of time durations can be stored in a look-up table format. For example, a look up table can be defined that stores a set of time duration thresholds corresponding to the boundaries between the ranges of time durations and the fast navigation speeds associated with each of the ranges of time duration. The identification of the predefined time duration range can then be performed by comparing the time duration 415 of the selected digital video sequence 405 to the set of time duration thresholds.

The fast navigation speed 425 can represent the navigation speed using any appropriate method known in the art. In some embodiments, the fast navigation speed 425 is a navigation speed multiplier (e.g., 1×, 2×, 4×, 8× or 16×) expressing the navigation speed as a multiplier of a reference navigation speed. In other embodiments, the fast navigation speed 425 is a frame interval indicating the number of frames that should be advanced in a predefined time interval (e.g., 1/60 second).

An initialize current frame step 435 is used to initialize a current frame 440 from the digital video sequence 405. In some embodiments, the current frame 440 is initialized to be the frame which is currently displayed on the image display 32 with the fast navigation operation is initiated. In other embodiments, the current frame 440 can be initialized to a predefined frame, such as the first frame of the digital video sequence 405. In some embodiments where the fast navigation operation is initiated as part of a video trimming process, the current frame 440 is initialized to the previous location of the start frame or end frame that the user wants to adjust.

In some embodiments, an optional display current frame step 445 is used to display the current frame 440 on the image display 32. An optional display current frame location step 450 can also be used to display an indication of the location of the current frame 440 within the digital video sequence 405 on the image display 32. For example, the GUI on the image display can include graphical elements representing a timeline for the digital video sequence 405, together with a marker indicating the relative location of the current frame 440 within the timeline.

An update current frame step 455 is used to update the current frame 440 responsive to the fast navigation speed 425. For example, if the fast navigation speed 425 is a frame interval indicating the number of frames that should be advanced, the updated current frame 440 can be determined by advancing the frame number according to the frame interval. This process can be repeated iteratively until the fast navigation operation is terminated, or until the end (or beginning) of the digital video sequence 405 has been reached. In a preferred embodiment, the update current frame step 455 is performed periodically according to a predefined frame rate (e.g., 60 frames/sec).

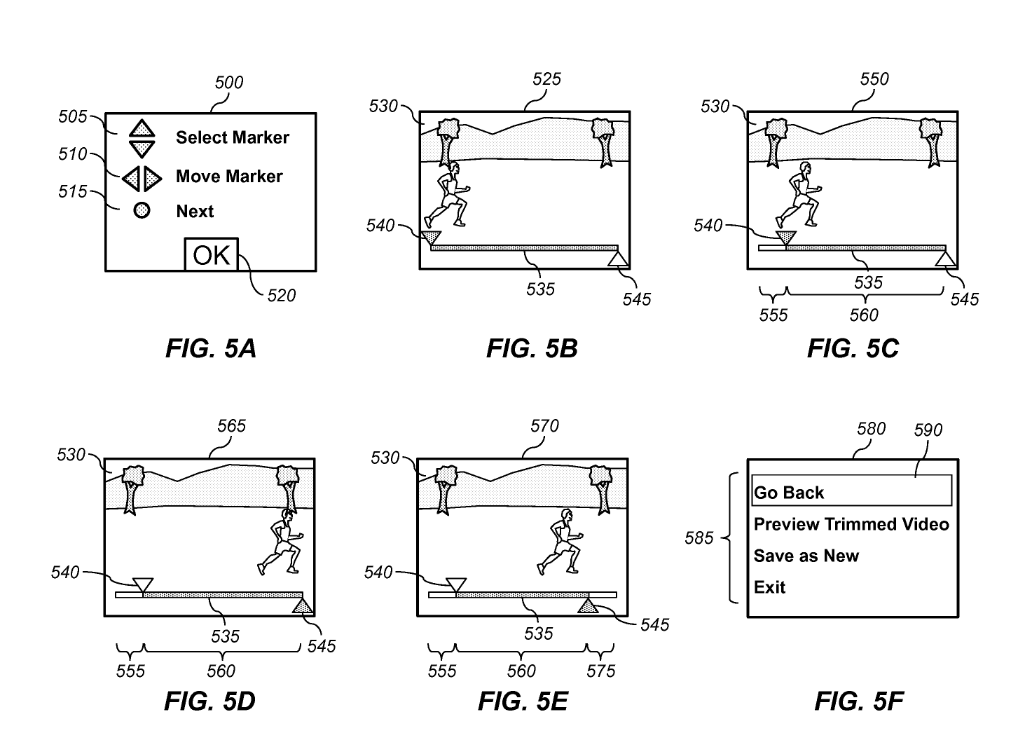

FIGS. 5A-5F illustrate a video trimming process that uses fast navigation operations to position a start frame marker 540 and an end frame marker 545 defining the start frame and the end frame for the trimmed video sequence. In some embodiments, when the video trimming process is initiated for a selected digital video sequence 405 (FIG. 4), a user interface screen 500 is displayed which presents instructions to the user as shown in FIG. 5A. In this example, select marker instructions 505 provide an indication that the up input and the down input can be used to select between a start frame marker and an end frame marker. Move marker instructions 510 provide an indication that the left input and the right input can be used to move the selected frame marker. Next instructions 515 provide an indication that the confirmation input can be used to advance to the next step in the video trimming process. An OK control 520 provides an indication that the user should activate the confirmation input when he is done looking at the user interface screen 500.

After the user has exited the instructions screen, a user interface for the video trimming operation is displayed on the image display 32 (FIG. 3A). FIG. 5B shows an example of a user interface screen 525 showing a displayed video frame 530 corresponding to the current frame 440 (FIG. 4) of the selected digital video sequence 405 (FIG. 4), together with appropriate user interface elements. In a preferred embodiment, the current frame 440 is initialized to be the first frame of the digital video sequence 405. A timeline 535 is also displayed that represents the time interval of the selected digital video sequence 405. The total time associated with the time interval corresponds to the time duration 415 (FIG. 4). The start frame marker 540 indicates the start frame for the trimmed digital video sequence and the end frame marker 545 indicates the end frame for the trimmed digital video sequence.

In the example shown in FIGS. 5B-5E, the timeline 535 is always the same size independent of the time duration 415 (FIG. 4) of the selected digital video sequence 405 (FIG. 4). Therefore, the positions of the start frame marker 540 and the end frame marker 545 indicate the relative positions of the start and end frames within the time duration 415 of the digital video sequence 405. In other embodiments, the length of the timeline 535 can be adjusted according to the time duration 415 relative to a fixed time scale so that longer video clips will be displayed with proportionally longer timelines. In this case, the positions of the start frame marker 540 and the end frame marker 545 would provide an indication of the absolute positions of the start and end frames with respect to the fixed time scale.

The positions of the start frame marker 540 and the end frame marker 545 relative to the timeline 535 provides an indication of the relative position of the respective frames within the selected digital video sequence 405. At the start of the video trimming process, the start frame marker 540 is positioned at the first frame of the selected digital video sequence 405, the end frame marker 545 is positioned at the last frame of the selected digital video sequence 405, and the entire timeline 535 is highlighted indicating that the entire digital video sequence 405 is initially included in the trimmed digital video sequence. Initially, the video trimming process starts out in a start frame selection mode. Accordingly, the start frame marker 540 is highlighted indicating that it is the active frame marker.

The user uses the user controls 34 (FIG. 3A) to select the start frame (and also the end frame) for the trimmed digital video sequence. The user can use the right input button 320 (FIG. 3A) and left input button 315 (FIG. 3A) to adjust the position of the start frame marker 540 (FIG. 5B) in order to adjust the starting point for the trimmed digital video sequence. As the position of the start frame marker 540 is adjusted, the displayed video frame 530 (FIG. 5B) is adjusted to show the corresponding frame of the selected digital video sequence 405 (FIG. 4).

In a preferred embodiment, if the right input button 320 (FIG. 3A) is pressed and held a fast navigation operation is initiated (specifically a fast forward operation). The initialize current frame step 435 (FIG. 4) initializes the current frame 440 (FIG. 4) to correspond to the current position of the start frame marker 540. During the fast navigation operation, the start frame marker 540 advances across the timeline 535 as the current frame 440 (FIG. 4) is updated, and the displayed video frame 530 advances through the selected digital video sequence 405 according to the fast navigation speed 425 (FIG. 4). In some embodiments, the current frame 440 may by advanced at a predefined initial speed (e.g., 1×) until the right input button 320 is held for a predefined threshold period of time. In a preferred embodiment, if the right input button 320 is pressed and released without holding it, then the start frame marker 540 advances by a single frame, or by a predefined number of video frames corresponding to a predefined small time interval. Similarly, the left input button 315 (FIG. 3A) can be used to move the start frame marker 540 to the left, thereby moving through the selected digital video sequence in a reverse direction. In accordance with the present invention, if the left input button 315 is pressed and held a fast navigation operation is initiated (specifically a fast reverse operation).

FIG. 5C shows an example of a user interface screen 550 where the position of the start frame marker 540 has been moved to the right partway across the timeline 535. The portion of the timeline between the start frame marker 540 and the end frame marker 545 is highlighted indicating a trimmed timeline portion 560. The portion of the timeline 535 to the left of the start frame marker 540 is not highlighted, indicating an excluded start timeline portion 555.

If the user now presses the up input button 305 (FIG. 3A) or the down input button 310 (FIG. 3A), the mode is changed from the start frame selection mode to an end frame selection mode. This is illustrated in the user interface screen 565 of FIG. 5D, which is identical to the user interface screen 550 of FIG. 5C except that the end frame marker 545 is now highlighted rather than the start frame marker 540. (The highlighting of the corresponding frame marker provides a graphical indication of whether the user has selected the start frame selection mode or then end frame selection mode.) The displayed video frame 530 now shows the video frame corresponding to the end frame marker 545 (initially the last frame of the selected digital video sequence 405).

In the end frame selection mode, the right input button 320 (FIG. 3A) and left input button 315 (FIG. 3A) can be used to adjust the position of the end frame marker 545 in order to adjust the ending point for the trimmed digital video sequence. If the right input button 320 or the left input button 315 is pressed and held, a fast navigation operation is initiated in the forward or reverse direction, respectively. The initialize current frame step 435 (FIG. 4) initializes the current frame 440 (FIG. 4) to correspond to the current position of the end frame marker 545. As the position of the end frame marker 545 is adjusted, the displayed video frame 530 is adjusted as the current frame 440 is updated to show the corresponding frame of the selected digital video sequence 405. The behavior of the right input button 320 and left input button 315 in the end frame selection mode will be analogous to those described above for the start frame selection mode.

FIG. 5E shows an example of a user interface screen 570 where the position of the end frame marker 545 has been moved to the left partway across the timeline 535. As described earlier, the portion of the timeline between the start frame marker 540 and the end frame marker 545 is highlighted indicating the trimmed timeline portion 560. The portion of the timeline 535 to the right of the end frame marker 545 is not highlighted, indicating an excluded end timeline portion 575.

The up input button 305 (or the down input button 310) can be used to toggle back and forth between the start frame selection mode and the end frame selection mode. In this way, the user can fine tune the position of the start frame marker 540 and the end frame marker 545 until he/she is satisfied with the designated trimmed digital video sequence. At that point, the user can press the confirmation input button 325 (FIG. 3A) to move to the next step in the video trimming operation.

In a preferred embodiment, pressing the confirmation input button 325 (FIG. 3A) terminates the user input process and causes the trimmed digital video sequence to be formed and stored in a processor-accessible memory. In other embodiments, it only causes an indication of the selected start frame and end frame to be stored so that they can be used at a later time to form the trimmed digital video sequence.

In some embodiments, if the user presses the confirmation input button 325 before they have entered the end frame selection mode using the up input button 305 or the down input button 310, the video trimming process makes the assumption that the user will first want to enter the end frame selection mode. In this case, a second activation of the confirmation input button 325 will terminate the user input process.

In some embodiments, terminating the user input process causes the video trimming process to advance to an optional confirm trimming selection step. FIG. 5F shows an example of a user interface screen 580 that can be used for the confirm trimming selection step. The user interface screen 580 includes a set of menu choices 585, indicating the available options. A selection box 590 is positioned over the currently selected choice. The up input button 305 (FIG. 3A) and the down input button 310 (FIG. 3A) can be used to move the selection box 590 up or down through the list of menu choices 585. When the selection box 590 is over the desired choice, the user can activate that choice using the confirmation input button 325 (FIG. 3A).

The menu choices 585 include a “Go Back” choice which can be used to return to the start/end frame selection process. A “Preview Trimmed Video” choice can be used to preview the trimmed digital video sequence as specified by the selected start frame and end frame. An “Exit” choice exits the video trimming operation without saving the trimmed digital video sequence. A “Save as New” choice causes the video trimming operation to form the trimmed digital video sequence by trimming the selected digital video sequence 405 (FIG. 4) to include the frames between the selected start frame and end frame. The trimmed digital video sequence is then stored in the image memory 30 (FIG. 1).

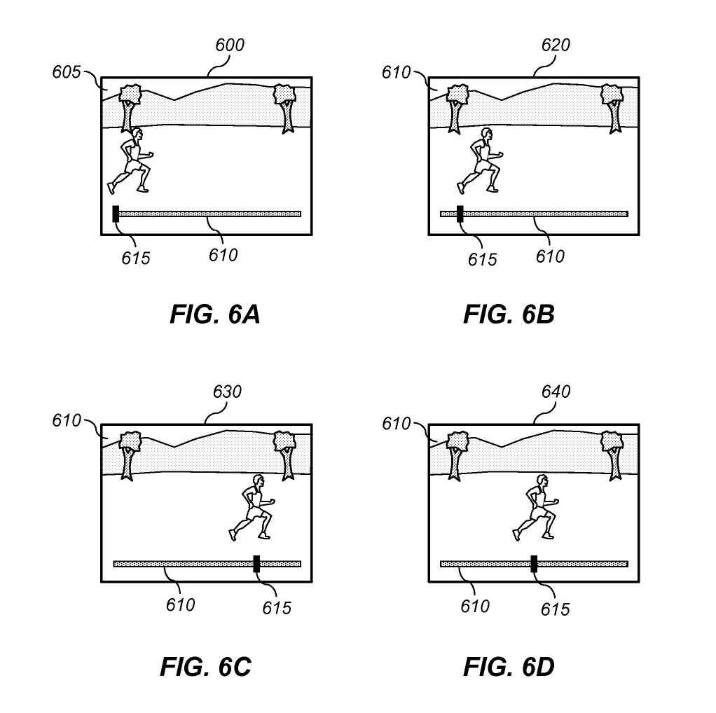

FIGS. 6A-6D illustrate the use of a fast navigation process during the viewing of a selected digital video sequence 405 (FIG. 4). FIG. 6A shows a video playback screen 600 that is displayed when a video playback operation is initiated (for example by pressing the confirmation input button 325 (FIG. 3A)). The video playback screen 600 includes a displayed video frame 605 corresponding to the first frame of the digital video sequence 405. The video playback screen 600 also includes graphical elements providing an indication of the relative position of the displayed video frame 605 within the digital video sequence 405. Specifically, the graphical elements include a timeline 610 and a current frame marker 615. In FIG. 6A, the current frame marker 615 is shown at the left end of the timeline 610 indicating that the displayed video frame 605 is at the beginning of the digital video sequence 405.

As the video playback operation progresses, the displayed video frame 605 as the selected digital video sequence 405 (FIG. 4) is played. The position of the current frame marker 615 is also updated accordingly. FIG. 6B shows an updated video playback screen 620 after approximately 10% of the digital video sequence 405 has been viewed.

During the playback operation, the user can initiate a fast navigation operation by interacting with the user controls 34. For example, the user can press and hold the right input button 320 (FIG. 3A) to initiate a fast forward operation. As the fast navigation operation progresses in a forward direction during the time that the user is holding down the right input button 320, the displayed video frame 605 and the position of the current frame marker 615 are updated as the current video frame is updated in accordance with the fast navigation speed 425 (FIG. 4). FIG. 6C shows an updated video playback screen 630 after the fast navigation operation has progressed through approximately 80% of the digital video sequence 405.

At this point, if the user decides that they would like to go back and view an earlier portion of the video, they can release the right input button 320 and then press and hold the left input button 315 to initiate a fast reverse operation. As the fast navigation operation progresses in the reverse direction during the time that the user is holding down the left input button 315, the displayed video frame 605 and the position of the current frame marker 615 are updated as the current video frame is updated in accordance with the fast navigation speed 425 (FIG. 4). FIG. 6D shows an updated video playback screen 640 after the fast navigation operation has progressed in a reverse direction to a point which is approximately 50% of the way through the digital video sequence 405. At this point, if the user releases the left input button 315, the remainder of the selected digital video sequence 405 will play at a normal speed (unless the user pauses or terminates the playback, or initiates another fast navigation operation).

In some embodiments, different types of graphical elements can be used to provide an indication of progress through the selected digital video sequence. For example, rather than showing the current frame marker 615 on the timeline 610, the color or shading of the timeline can be adjusted to indicate the relative location of the current frame (e.g., the portion of the timeline to the left of the current frame location can be displayed with a different color than the portion of the timeline to the right of the current frame location.) In another example, the indication of the current frame position can be a numerical representation of a time difference (e.g., in minutes and seconds) between a time associated with the current frame 440 and a time associated with designated reference video frame (e.g., the first frame of the digital video sequence 405). In yet another example, the indication of the current frame position can be a numerical representation of a frame number for the current frame 440. In some embodiments, the indication of the relative position of the current frame (e.g., the timeline 610 and accompanying current frame marker 615) may be omitted from the user interface altogether. In other embodiments, the displayed video frame 605 is not updated as the fast navigation operation progresses and the progress is only represented using the graphical elements.

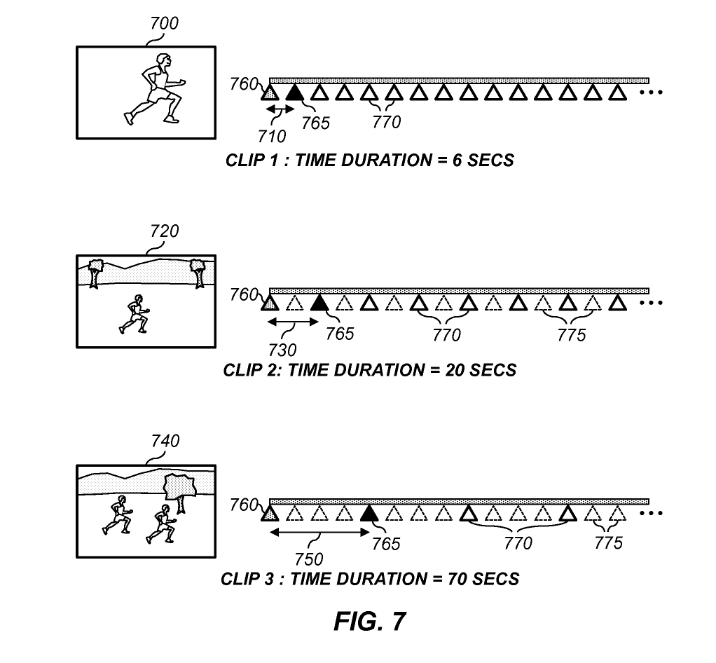

As discussed earlier with reference to FIG. 4, the determine time duration step 410 is used to determine the time duration 415 for the selected digital video sequence 405. The determine fast navigation speed step 420 then determines the fast navigation speed 425 responsive to the time duration 415. FIG. 7 shows three video clips (first digital video sequence 700, second digital video sequence 720 and third digital video sequence 740) having different time durations (a first time duration of 6 seconds, a second time duration of 20 seconds and a third time duration of 70 seconds)

When a fast navigation process is applied to the video clips shown in FIG. 7, different fast navigation speeds 425 (FIG. 4) will be determined in accordance with the different time durations 415 (FIG. 4). In an exemplary embodiment, the fast navigation speed 425 is determined using a fast navigation speed look-up table (LUT) defined according to the data shown in Table 1. The first column shows ranges of time durations that are to be associated with the fast navigation speeds shown in the third column. The second column shows the time duration thresholds representing the boundaries between the ranges of time durations in the first column. The second and third columns can be stored in the fast navigation speed LUT, which can be used by the determine fast navigation speed step 420 (FIG. 4). The last column of Table 1 shows the total time that would be required to traverse the entire digital video sequence 405 using the fast navigation process.

TABLE 1
Fast navigation speed table

| Range of time | Time duration | Fast navigation | Total time to traverse |
|---|---|---|---|
| durations (sec) | threshold (sec) | speed | video clip (sec) |
| 0-15 | 15 | 1x | 0-15 |
| 16-60 | 60 | 2x | 8-30 |
| 61-240 | 240 | 4x | 15-60 |
| 241-960 | 960 | 8x | 30-120 |
| >960 | N/A | 16x | >60 |

According to the exemplary fast navigation speed table shown in Table 1, a 1× fast navigation speed would be determined for the first digital video sequence 700, a 2× fast navigation speed would be determined for the second digital video sequence 720 and a 4× fast navigation speed would be determined for the third digital video sequence 740.

In other embodiments, the fast navigation speed 425 (FIG. 4) can be determined using an equation rather than a fast navigation speed LUT. For example, the fast navigation speed 425 can be adjusted such that the total time to traverse the digital video sequence using the fast navigation process is a constant value. One such equation is given by:

$${S}_{f} = \{ \begin{matrix}1 ; & {T}_{v} < {T}_{f} \\ Round ( {T}_{v} / {T}_{f} ) ; & {T}_{v} \geq {T}_{f}\end{matrix} \qquad ( 6 )$$

where S_{f} is the fast navigation speed 425, Tᵥ is the time duration 415 for the digital video sequence, T_{f} is a predefined nominal total time to traverse the digital video sequence in the fast navigation mode, and Round(•) is a nearest integer rounding operation. In one embodiment, T_{f} is set to 15 sec.

In some embodiments, when the user initiates the fast navigation operation, there is a time delay between the time when the user control 34 is activated and the time when the fast navigation operation starts. During the time delay, the current frame is moves forward (or moves in reverse) at the nominal speed (1×). If the user releases the user control before the time delay is complete, the current frame is never updated using the fast navigation speed. This has the advantage that if the user has navigated to a frame near to a desired location, the location can be fine tuned by activating the user control 34 for a time period that is less than the time delay.

In some embodiments, different time delays can be used depending on the time duration 415 of the selected digital video sequence 405. Table 2 shows an exemplary set of time delays that can be used according to one embodiment.

TABLE 2
Fast navigation speed table with time delays

| Time duration | Time duration | Fast navigation | |
|---|---|---|---|
| (sec) | threshold (sec) | speed | Time delay (sec) |
| 0-15 | 15 | 1x | 0 |
| 16-60 | 60 | 2x | 2 |
| 61-240 | 240 | 4x | 2 |
| 241-960 | 960 | 8x | 4 |
| >960 | N/A | 16x | 8 |

In the example shown in FIG. 7, the initialize current frame step 435 (FIG. 4) initializes the current frame 440 (FIG. 4) to be the first frame 760 of the digital video sequence. In a preferred embodiment of the fast navigation process, a series of frames are selected to be displayed at a predefined frame rate (e.g., 60 frames/sec).

When the fast navigation speed 425 (FIG. 4) is a 1× fast navigation speed as will be the case for the first digital video sequence 700 in FIG. 7, all of the frames in the digital video sequence 405 (FIG. 4) are displayed (corresponding to a first frame interval 710 of 1 frame). Therefore, the next frame 765 will be the second frame, and each of the remaining frames will be displayed in turn. (Displayed frames 770 are shown as triangles with a solid outline.)

When the fast navigation speed 425 (FIG. 4) is a 2× fast navigation speed, as will be the case for the second digital video sequence 720 in FIG. 7, only every second frame in the digital video sequence 405 (FIG. 4) will be displayed (corresponding to a second frame interval 730 of 2 frames). Therefore, in this case, the next frame 765 will be the third frame, and every second frame will be a displayed frame 770. The remaining frames are skipped frames 775, which shown as triangles with a dotted outline.

Likewise, when the fast navigation speed 425 (FIG. 4) is a 4× fast navigation speed, as will be the case for the third digital video sequence 740 in FIG. 7, only every fourth frame in the digital video sequence 405 (FIG. 4) will be displayed (corresponding to a third frame interval 750 of 4 frames). Therefore, in this case, the next frame 765 will be the fifth frame, and every fourth frame will be a displayed frame 770. The remaining frames are skipped frames 775.

In an alternate embodiment, rather than controlling the fast navigation speed 425 (FIG. 4) by simply adjusting the frame interval to skip frames during the fast navigation process, the frame rate at which the frames are traversed can also be controlled. For example, the frame rate can be doubled to provide a 2× fast navigation speed while keeping the frame interval at a single frame. In some embodiments, both the frame rate and the frame interval can be adjusted to achieve a particular fast navigation speed 425. For example, an 8× fast navigation speed can be provided using a 2× frame rate and a frame interval of 4 frames.

In some embodiments, the digital video sequence 405 (FIG. 4) is stored in a compressed digital video file. Typically, some of the frames in a compressed digital video files are “I-frames,” which are encoded using intra-frame compression (which is independent of any other frames), and other frames are “P-frames” or “B-frames” that are encoded using predictions based on other nearby frames. Therefore, I-frames can be decoded without the need to decode any other frames. In these cases, the frames selected to be the displayed frames 770 can be adjusted to be the closest I-frames to simplify the decompression process.

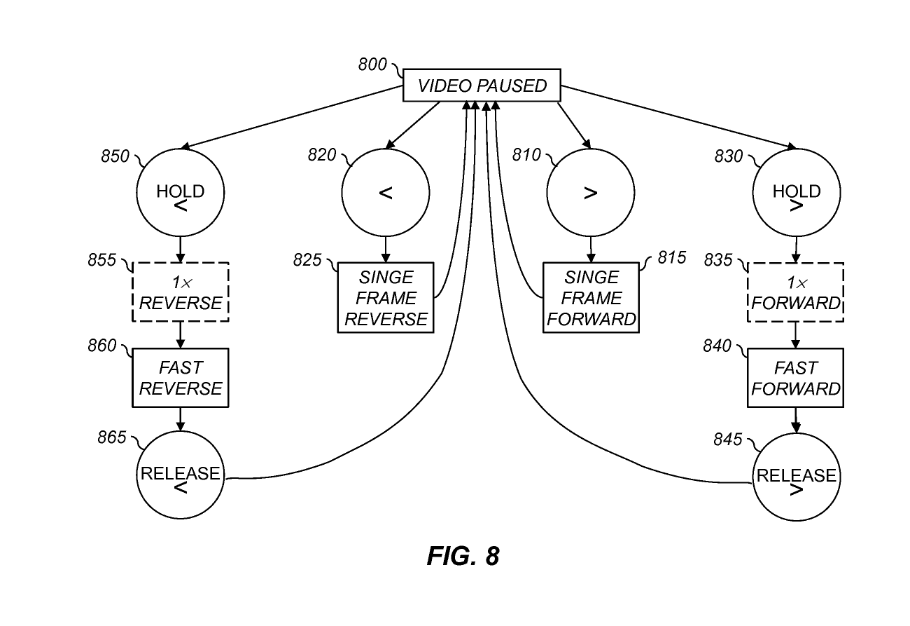

FIG. 8 shows a state diagram illustrating the operation of various user controls 34 (FIG. 3A) to interact with a paused video according to an exemplary embodiment of the present invention. The process starts with a selected digital video sequence 405 (FIG. 4) in a video paused state 800. The video paused state 800 can be entered according to various scenarios. For example, the video paused state 800 can correspond to a digital video sequence 405 which has been selected for playback, but where a play operation has not been initiated. It can also correspond to a digital video sequence 405 which has been paused during playback. In a video trimming process, the video paused state 800 can correspond to the state where the user has selected either the start frame or the end frame for adjustment.

From the video paused state 800, a press right input button step 810 can be performed to initiate a single frame forward operation 815 which advances the current frame by a single frame in the forward direction (or alternately by a predefined number of frames). The video playback process then returns to the video paused state 800.

Similarly, a press left input button step 820 can be performed to initiate a single frame reverse operation 825 which advances the current frame by a single frame in the reverse direction (or alternately by a predefined number of frames). The video playback process then returns to the video paused state 800.

From the video paused state 800, a hold right input button step 830 can be performed to enter a fast forward state 840, which advances the current frame according to the fast navigation speed 425 (FIG. 4). (In this case, the hold right input button step 830 performs the function of the initiate fast navigation step 430 (FIG. 4).) As was discussed earlier with reference to Table 2, in some embodiments, an optional time delay can be used before entering the fast forward state 840, during which time the video playback can be advanced in a 1× forward state 835. A release right input button step 845 returns the video playback process to the video paused state 800.

Similarly, a hold left input button step 850 can be performed to enter a fast reverse state 860, which moves backwards at a rate specified by the fast navigation speed 425 (FIG. 4). (In this case, the hold left input button step 850 performs the function of the initiate fast navigation step 430 (FIG. 4).) As was discussed earlier with reference to Table 2, in some embodiments, an optional time delay can be used before entering the fast reverse state 860, during which time the video playback can be advanced in a reverse direction in a 1× reverse state 855. A release left input button step 865 returns the video playback process to the video paused state 800.

In the context of the process described with reference to FIG. 8, the initialize current frame step 435 (FIG. 4) designates the video frame that is displayed when the fast forward state 840 or the fast reverse state 860 is initiated to be the initial current frame 440 (FIG. 4). In accordance with the present invention, the fast navigation speed 425 (FIG. 4) associated with the fast forward state 840 and the fast reverse state 860 in FIG. 8 is determined response to the time duration 415 (FIG. 4) of the selected digital video sequence 405 (FIG. 4).

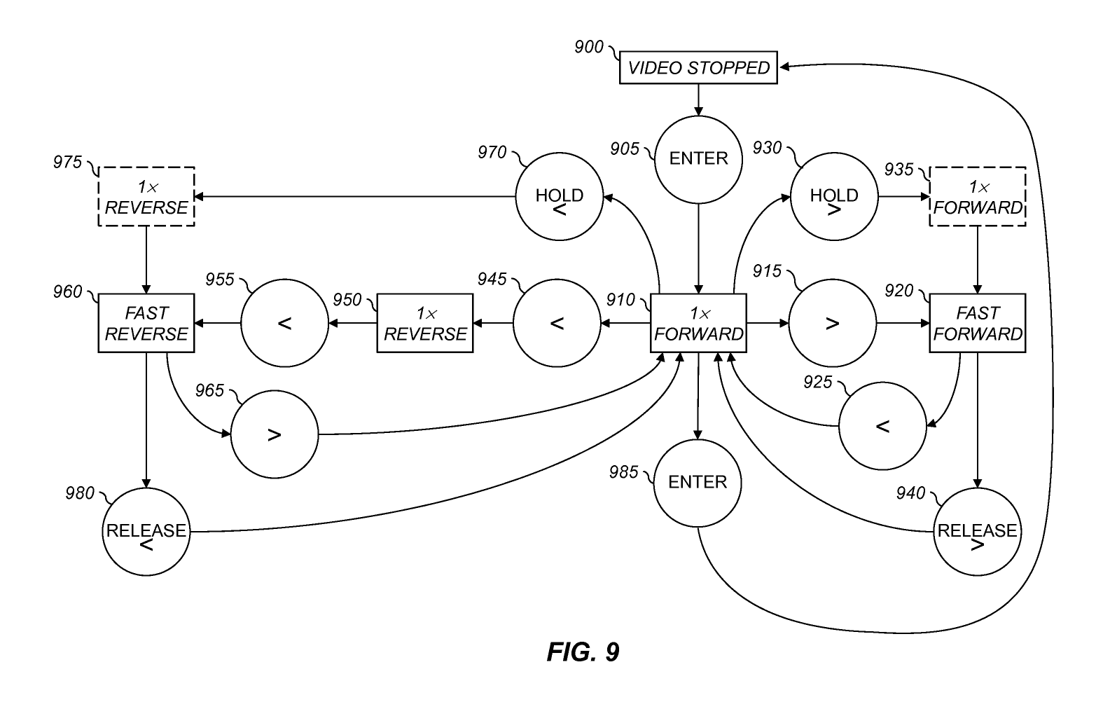

FIG. 9 shows a state diagram illustrating the operation of various user controls 34 (FIG. 3A) to interact with a playing video according to an exemplary embodiment of the present invention. The process starts with a selected digital video sequence 405 (FIG. 4) in a video stopped state 900. A press confirmation input button step 905 is used to start playing the digital video sequence 405, placing it into a 1× forward state 910.

From the 1× forward state 910, a press right input button step 915 can be performed to enter a fast forward state 920, which advances the current frame at a rate given by the fast navigation speed 425 (FIG. 4). (In this case, the press right input button step 915 performs the function of the initiate fast navigation step 430 (FIG. 4).) A press left input button step 925 can be performed to return to the 1× forward state 910.

Similarly, a press left input button step 945 can be performed to enter a 1× reverse state 950 which plays the selected digital video sequence 405 (FIG. 4) in the reverse direction. A second press left input button step 955 can be performed to enter a fast reverse state 960, which advances the current frame in a reverse direction at a rate given by the fast navigation speed 425 (FIG. 4). (In this case, the press left input button step 955 performs the function of the initiate fast navigation step 430 (FIG. 4).) A press right input button step 965 can be performed to return to the 1× forward state 910.

From the 1× forward state 910, a hold right input button step 930 can be performed to directly enter the fast forward state 920. (In this case, the hold right input button step 930 performs the function of the initiate fast navigation step 430 (FIG. 4).) As was discussed earlier with reference to Table 2, in some embodiments, an optional time delay can be used before entering the fast forward state 920, during which time the video playback can be advanced in a 1× forward state 935. A release right input button step 940 returns the video playback process to the 1× forward state 910.

Similarly, a hold left input button step 970 can be performed to directly enter the fast reverse state 960. (In this case, the hold left input button step 970 performs the function of the initiate fast navigation step 430 (FIG. 4).) As was discussed earlier with reference to Table 2, in some embodiments, an optional time delay can be used before entering the fast reverse state 960, during which time the video playback can be advanced in a reverse direction in a 1× reverse state 975. A release left input button step 980 returns the video playback process to the 1× forward state 910.

When the user is done playing the digital video sequence 405 (FIG. 4), a press confirmation input button step 985 can be used to return to the video stopped state 900.

In the context of the process described with reference to FIG. 9, the initialize current frame step 435 (FIG. 4) designates the video frame that is displayed when the fast forward state 920 or the fast reverse state 960 is initiated to be the initial current frame 440 (FIG. 4). In accordance with the present invention, the fast navigation speed 425 (FIG. 4) associated with the fast forward state 920 and the fast reverse state 960 in FIG. 9 is determined response to the time duration 415 (FIG. 4) of the selected digital video sequence 405 (FIG. 4).

It should be understood that the state diagrams shown in FIGS. 8 and 9 represent user interface designs which are presented for illustrative purposes only. It will be obvious to one skilled in the art that a wide variety of user interface designs can be used to implement the fast navigation process of the present invention. In other embodiments, different user controls and steps can be used to initiate and terminate the fast navigation process.

While the exemplary embodiments have been described with reference to a digital camera 10 having the capability to capture, view and edit digital video sequences 405 (FIG. 4), it will be understood that the present invention can be practiced using any type of digital video display device. For example, it can be implemented as a feature of a digital media frame (e.g., a digital picture frame), a digital video player (e.g., a DVD player) or a digital video recorder (e.g., a TiVo).

The invention has been described in detail with particular reference to certain preferred embodiments thereof, but it will be understood that variations and modifications can be effected within the spirit and scope of the invention.

### PARTS LIST

2 flash
4 lens
6 adjustable aperture and adjustable shutter
8 zoom and focus motor drives
10 digital camera
12 timing generator
14 image sensor
16 ASP and A/D Converter
18 buffer memory
20 processor
22 audio codec
24 microphone
26 speaker
28 firmware memory
30 image memory
32 image display
34 user controls
36 display memory
38 wired interface
40 computer
44 video interface
46 video display
48 interface/recharger
50 wireless modem
52 radio frequency band
58 wireless network
70 Internet
72 photo service provider
90 white balance setting
95 white balance step
100 color sensor data
105 noise reduction step
110 ISO setting
115 demosaicing step
120 resolution mode setting
125 color correction step
130 color mode setting
135 tone scale correction step
140 contrast setting
145 image sharpening step
150 sharpening setting
155 image compression step
160 compression mode setting
165 file formatting step
170 metadata
175 user settings
180 digital image file
185 camera settings
190 environmental readings
300 five-way controller
305 up input button
310 down input button
315 left input button
320 right input button
325 confirmation input button
330 share button
335 delete button
340 review button
345 capture mode button
350 tools button
360 controller ring
365 joy stick
370 up direction
375 down direction
380 left direction
385 right direction
400 select video sequence step
405 digital video sequence
410 determine time duration step
415 time duration
420 determine fast navigation speed step
425 fast navigation speed
430 initiate fast navigation step
435 initialize current frame step
440 current frame
445 display current frame step
450 display current frame location step
455 update current frame step
500 user interface screen
505 select marker instructions
510 move marker instructions
515 next instructions
520 OK control
525 user interface screen
530 displayed video frame
535 timeline
540 start frame marker
545 end frame marker
550 user interface screen
555 excluded start timeline portion
560 trimmed timeline portion
565 user interface screen
570 user interface screen
575 excluded end timeline portion
580 user interface screen
585 menu choices
590 selection box
600 video playback screen
605 displayed video frame
610 timeline
615 current frame marker
620 video playback screen
630 video playback screen
640 video playback screen
700 first digital video sequence
710 first frame interval
720 second digital video sequence
730 second frame interval
740 third digital video sequence
750 third frame interval
760 first frame
765 next frame
770 displayed frames
775 skipped frames
800 video paused state
810 press right input button step
815 single frame forward operation
820 press left input button step
825 single frame reverse operation
830 hold right input button step
835 1× forward state
840 fast forward state
845 release right input button step
850 hold left input button step
855 1× reverse state
860 fast reverse state
865 release left input button step
900 video stopped state
905 press confirmation input button step
910 1× forward state
915 press right input button step
920 fast forward state
925 press left input button step
930 hold right input button step
935 1× forward state
940 release right input button step
945 press left input button step
950 1× reverse state
955 press left input button step
960 fast reverse state
965 press right input button step
970 hold left input button step
975 1× reverse state
980 release left input button step
985 press confirmation input button step

1. A digital video display device having an adaptive fast navigation mode for navigating through a digital video sequence having a time sequence of video frames, comprising:
a display;
a user interface including one or more user controls;
a data processing system;
a program memory communicatively connected to the data processing system and storing instructions configured to cause the data processing system to implement a method for providing the adaptive fast navigation mode, wherein the method includes:
selecting a digital video sequence stored in a processor-accessible memory;
determining a time duration associated with the selected digital video sequence;
initiating a fast navigation operation in response to user activation of an appropriate user control;
determining a fast navigation speed responsive to the time duration of the selected digital video sequence;
designating a particular video frame in the selected digital video sequence to be a current video frame; and
periodically updating the designation of the current video frame in accordance with the determined fast navigation speed.

2. The digital video display device of claim 1 wherein the fast navigation operation is a fast playback operation, and wherein current video frames in the selected digital video sequence are displayed on the display in accordance with the determined fast navigation speed.

3. The digital video display device of claim 2 wherein the fast playback operation is a fast forward operation or a fast reverse operation.

4. The digital video display device of claim 1 wherein the fast navigation operation is used during the selection of a start frame or an end frame in a video trimming process.

5. The digital video display device of claim 1 wherein a visual representation of a location of the current video frame within the selected digital video sequence is displayed on the display during the fast navigation operation.

6. The digital video display device of claim 5 wherein the location of the current video frame within the selected digital video sequence is a relative location.

7. The digital video display device of claim 5 wherein the location of the current video frame within the selected digital video sequence is an absolute location.

8. The digital video display device of claim 5 wherein the visual representation of the location includes a timeline graphic including a current video frame location indicator.

9. The digital video display device of claim 5 wherein the visual representation of the location includes a numerical representation of a frame number for the current video frame.

10. The digital video display device of claim 5 wherein the visual representation of the location includes a numerical representation of a time difference between a time associated with the current video frame and a time associated with designated reference video frame.

11. The digital video display device of claim 1 wherein the time duration is the total time duration for the selected digital video sequence.

12. The digital video display device of claim 1 wherein the time duration is the time interval between a current video frame and a last video frame if the fast navigation operation is a fast forward navigation operation, and wherein the time duration is the time interval between a current video frame and a first video frame if the fast navigation operation is a fast reverse navigation operation.

13. The digital video display device of claim 1 wherein the determination of the fast navigation speed includes:
predefining a discrete set of available fast navigation speeds, each of the available fast navigation speeds being associated with a corresponding predefined range of time durations;
identifying the predefined range of time durations that includes the time duration of the selected digital video sequence; and
determining the fast navigation speed to be the available fast navigation speeds corresponding to the identified time duration range.

14. The digital video display device of claim 13 wherein the identification of the predefined time duration range that includes the time duration of the selected digital video sequence is performed using a stored look-up table.

15. The digital video display device of claim 13 wherein the identification of the predefined time duration range that includes comparing the time duration of the selected digital video sequence to a set of time duration thresholds corresponding to boundaries between the time duration ranges.

16. The digital video display device of claim 1 wherein the fast navigation speed is determined by addressing a navigation speed function using the time duration of the selected digital video sequence.

17. The digital video display device of claim 1 wherein the digital video display device is a digital camera, a digital media frame, a digital video player or a digital video recorder.
